(19) United States
(12) Patent Application Publication
(10) Pub. No.: US 2021/0388213 A1
(43) Pub. Date: Dec. 16, 2021

(54) PROCESS FOR PRODUCING AQUEOUS COATING COMPOSITIONS

(71) Applicant: CELANESE INTERNATIONAL CORPORATION, Irving, TX (US)

(72) Inventors: Stephan KRIEGER, Hofheim (DE); Harald PETRI, Aarbergen (DE); Vivian HEIJNEN, Bocholt (BE)

(21) Appl. No.: 17/281,576

(22) PCT Filed: Sep. 19, 2019
(86) PCT No.: PCT/US2019/051908

§ 371 Date: Mar. 30, 2021

Related U.S. Application Data
(60) Provisional application No. 62/741,137, filed on Oct. 4, 2018.

(51) Int. Cl. C09D 5/02; C09D 7/63; C09D 131/04; C09D 123/08

(52) U.S. Cl. CPC C09D 5/025; C09D 7/63; C08K 5/47; C09D 123/0853; C08K 2201/019; C09D 131/04

(57) ABSTRACT

A process for producing an aqueous coating composition comprises providing an aqueous polymer dispersion having a pH <7 and adding to the dispersion 1 to 30 ppm of 5-chloro-2-methyl-3(2H)-isothiazolone (CIT) and 10 to 1000 ppm of 2,2-dibro-mo-3-nitrilopropionamide (DBNPA), all by weight of the total weight of the dispersion. At least one adjuvant is also added to the dispersion to produce a coating composition. When the coating composition is to be put into service, the DBNPA is decomposed by raising the pH of the coating composition and the CIT is decomposed either by raising the pH of the coating composition or by adding a CIT-decomposing compound to the coating composition.

### FIELD

The present invention relates to a process for producing aqueous coating compositions, such as adhesives, paints, lacquers and varnishes, containing aqueous polymer dispersions.

### BACKGROUND

Aqueous polymer dispersions (latex emulsions) and coating compositions containing the same are susceptible to microbial contamination resulting in product spoilage. Polymer dispersions are composed of fine organic polymer particles in water. These polymer particles are suspended and stabilized in an aqueous environment with additional organic substrates, such as surfactants and protective colloids. Surfactants, protective colloids, such as poly(vinyl alcohol) and hydroxyethyl cellulose, thickeners and other additives, as well as the polymer itself provide a supply of carbon nutrition for microorganisms to metabolize. Polymer emulsions are therefore susceptible to spoilage due to microbial attack and propagation. Standard industrial practices seek to combat such product biodeterioration by the addition of various industrial biocides (antimicrobial agents) directly after the manufacturing process. Examples of commonly used industrial biocides are: 1,2-benzisothiazolin-3-one (BIT), 5-chloro-2-methyl-4-isothiazolin-3-one (CIT), 2-methyl-4-isothiazolin-3-one (MIT) and blends thereof.

However, isothiazolinone-based biocides are known to cause allergic contact dermatitis and, in fact, among commercial painters they are one of the most common causes of this medical condition. As a result, there is increasing publicity and regulation, especially in Europe, towards the reduction or elimination of isothiazolinone-based biocides in paints, lacquers and varnishes. For example, products in Europe containing more than 15 ppm of MIT will soon have to carry the H 317 hazard warning label “May cause an allergic skin reaction”, whereas the limit for this mandate for CIT/MIT (3: 1) is already <15 ppm. On the other hand, products, such as aqueous coating compositions, and their raw materials, such as aqueous polymer dispersions, need to be protected against biological attack. Therefore, there is need to provide adequate protection for aqueous polymer dispersions at the lowest possible biocide concentration while ensuring the most efficient biocide utilization. Furthermore, there is a need to remove the biocides emanating from the polymer dispersion before the final coating compositions, such as paints, are delivered to the end user.

International Patent Publication No. WO 2017/148572 discloses a method of reducing microbial infestation of a product comprising the steps of: (A) providing a product, such as a paint or polymer dispersion and (B) adding to the product 1 to 100 ppm of 5-chloro-2-methyl-4-isothiazolin-3-one containing 2-methyl -4-isothiazolin-3-one in the range of 0 to 2% by weight, based on the total amount of 5-chloro-2-methyl-4-isothiazolin-3-one, (C) decomposing the 5-chloro-2-methyl-4-isothiazolin-3-one using at least one 5-chloro-2-methyl-4-isothiazolone-decomposing compound and (D) adding at least one biocide selected from the group consisting of 1,2-benzisothiazolin-3-one in an amount of 1 to 1,000 ppm, 2,2-dibromo-3-nitrilopropionamide in an amount in the range of 1 to 2,500 ppm, 2,2-dibromomalonamide, tetramethylolacetylenediurea, formaldehyde, glutaraldehyde, phenoxyethanol, 2-bromo-2-nitropropane-1,3-diol in an amount in the range of 1 to 2,000 ppm, zinc pyrithione in an amount in the range of 1 to 2,500 ppm, sodium pyrithione, benzyl alcohol, 3-iodopropargyl-N-butylcarbamate, 2-n-octyl-4-is othiazolin-3-one, 4,5-dichloro-2-n-octyl-4-isothiazolin-3-one, a silver source in an amount ranging from 1 to 500 ppm, 2-methyl-1, 2-benzisothiazolin-3-one, ethylhexylglycerol, 1, 2-octanediol, 1,2-hexanediol, 1,2-pentanediol, 1,2-decanediol, propyl p-hydroxybenzoate, sorbic acid, benzoic acid , ascorbic acid, benzalkonium chloride, dimethyldidodecylammonium chloride, terbutryn, diuron, carbendazim, tebuconazole and o-phenylphenol.

However, it has now been found that at the concentrations of <15 ppm currently or shortly to be prescribed for CIT and CIT/MIT (3:1) in products, such as aqueous coating compositions, the protection against microbial attack is not sufficient.

Thus, there remains a need for a biocide treatment and removal process that allows aqueous polymer dispersions to be protected from microbial attack during storage, preferably while allowing the end product, such as an adhesive, paint, lacquer or varnish, to be labeled as preservative-free.

### SUMMARY

According to the invention, it has now been found that a combination of 1 to 30 ppm by weight of CIT, optionally with up to 10 ppm by weight of MIT, together with 10 to 1000 ppm by weight of 2,2-dibromo-3-nitrilopropionamide (DBNPA) provides effective protection against microbial attack, such as by yeast, bacteria and fungi, in aqueous polymer dispersions having a pH of<7. This was unexpected because of the limited stability of DBNPA. The advantage of the combination is that CIT and DBNPA can easily be removed from the final coating composition.

Thus, in one aspect, the invention resides in a process for producing an aqueous coating composition, the process comprising:

(i) providing an aqueous polymer dispersion having a pH <7;

(ii) adding to the dispersion 1 to 30 ppm of 5-chloro-2-methyl-3(2H)-isothiazolone (CIT) and 10 to 1000 ppm of 2,2-dibromo-3-nitrilopropionamide (DBNPA), all by weight of the total weight of the dispersion; and

(iii) adding at least one adjuvant to the dispersion to produce a coating composition;

(iv) raising the pH of the coating composition to a value sufficient to decompose the DBNPA; and

(v) adding a CIT-decomposing compound, preferably cysteine, to the coating composition to decompose the CIT.

In a further aspect, the invention resides in a process for producing an aqueous coating composition, the process comprising:

(i) providing an aqueous polymer dispersion having a pH <7;

(ii) adding to the dispersion 1 to 30 ppm of 5-chloro-2-methyl-3(2H)-isothiazolone (CIT), up to 10 ppm of 2-methyl-3(2H)-isothiazolone (MIT) and 10 to 1000 ppm of 2,2-dibromo-3-nitrilopropionamide (DBNPA), all by weight of the total weight of the dispersion; and

(iii) adding at least one adjuvant to the dispersion to produce a coating composition; and

(iv) adjusting the pH of the coating composition to a value of at least 10.5, preferably between 10.5 to 11.5, to decompose the DBNPA, CIT and, if present, MIT and to preserve the coating composition against microbial attack.

The invention also resides in coating compositions, such as adhesives, paints, lacquers and varnishes, produced by the processes described herein.

### DETAILED DESCRIPTION

The present disclosure relates to the production of aqueous coating compositions, such as adhesives, paints, lacquers and varnishes, from aqueous polymer dispersions, such as those produced by free radical initiated polymerization. In particular, the present disclosure provides a process in which microbial growth in the polymer dispersion and the final coating composition is effectively inhibited during production and storage of the coating composition by the addition of a specific combination of the biocides, 5-chloro-2-methyl-3(2H)-isothiazolone (CIT), 2,2-dibromo-3-nitrilopropionamide (DBNPA) and optionally 2-methyl-3(2H)-isothiazolone (MIT). Then, when the final coating composition is to be delivered to the end user, the CIT and DBNPA are decomposed either by chemical treatment or by raising the pH of the coating composition or both. Future microbial attack of the coating composition can then be prevented by the addition of a different, less hazardous biocide or by ensuring the pH of the coating composition is in excess of 10.5. In the latter case, the coating composition can be labeled preservative-free.

In a first embodiment, the present process comprises providing an aqueous polymer dispersion having a pH <7 and adding to the dispersion from 1 to 30 ppm, such as from 5 to 20 ppm, such as from 10 to 14.9 ppm, of CIT, and 10 to 1000 ppm, such as 20 to 400 ppm, such as 50 to 150 ppm, for example about 100 ppm, of DBNPA, all by weight of the total weight of the dispersion. Before or after adding the biocides, at least one adjuvant is added to the dispersion to produce a coating composition, which can then be stored substantially without microbial growth for up to 6 months. Subsequently, and before delivery to the end user, the pH of the coating composition is raised to a value, typically >8 but preferably less than 10, sufficient to decompose the DBNPA and a compound effective to decompose CIT is added to the coating composition to decompose the CIT. Suitable CIT-decomposing compounds include cysteine or derivative thereof, such as N-acetyl cysteine, mercaptoethanol, mercaptopropionic acid, methylmercaptopropionate, glutathione, thioglycolate, sodium thiosulfate, sodium bisulfite, pyrithione, mercaptopyridine, dithiothreitol, mercaptoethanesulfonate, and sodium formaldehyde sulfoxylate, with cysteine being preferred. In this way, despite the use of highly regulated biocides in its production and storage, the final coating composition reaching the end user is substantially free of such biocides and does not require a label, such as the H 317 hazard warning in Europe. To provide future preservation of the coating composition, less hazardous biocides can be added before release of the coating composition, for example 50 to 300 ppm, preferably 50 to 250 ppm, by weight zinc pyrithrione and/or 50 to 500, preferably 75 to 350 ppm, by weight of 1,2-benzisothiazolin-3-one (BIT) and/or 50 to 150 ppm by weight of 2-bromo-2-nitro-1,3-propanediol, all based on the total weight of the coating composition.

In the first embodiment, the amount of cysteine added to decompose the CIT will of course depend on the amount of CIT used to preserve the dispersion and coating composition. Generally, however, cysteine is added in a molar ratio of 1:1 to 2:1 with respect to the added CIT.

In a second embodiment, the present process again comprises providing an aqueous polymer dispersion having a pH <7 and adding to the dispersion 1 to 30 ppm, such as 1 to 20 ppm, such as 1 to 14.9 ppm, of CIT, and 10 to 1000 ppm, such as 20 to 400 ppm, such as 50 to 150 ppm, for example about 100 ppm, of DBNPA, all by weight of the total weight of the dispersion. Before or after adding the biocides, at least one adjuvant is added to the dispersion to produce a coating composition, which can then be stored substantially without microbial growth for up to 6 months. Subsequently, and before delivery to the end user, the pH of the coating composition is raised to a value of at least 10.5, preferably between 10.5 to 11.5, to decompose the DBNPA and CIT and to preserve the coating composition against microbial attack. The final coating composition can therefore be labeled preservative-free, where the term “preservative-free” means that the remaining biocide concentration of each of CIT/MIT and DBNPA is <1 ppm by weight, preferably <0.5 ppm by weight.

In the second embodiments, up to 10 ppm, such as up to 3 ppm, such as up to 1 ppm, of MIT can be added to the polymer dispersion along with the CIT and DBNPA, for example by adding at least part of the CIT in the form of the three-to-one blend of CIT/MIT available from many manufacturers. Preferably, in both the first and second embodiments, no measurable amount of MIT is added to the polymer dispersion.

In each of the first and second embodiments, raising the pH of the coating composition to decompose the DBNPA or the DBNPA, the CIT and, where present, the MIT, is conveniently effected by adding one or more of an alkali metal hydroxide, an alkali metal silicate, an alkylalkoxysilane, an alkylalkoxysiloxane and an alkysiliconate to the coating composition. It will be appreciated that certain adjuvants, such as calcium carbonate used as a filler, can also raise the pH of the coating composition but this is generally insufficient to cause significant decomposition of the biocides added as preservatives.

### Aqueous Polymer Dispersions

The aqueous polymer dispersions used in the present process are generally produced by free-radically initiated polymerization of one or more main monomers. Suitable main monomers are selected from C₁-C₂₀-alkyl (meth)acrylates, vinyl esters of carboxylic acids with up to 20 carbons, vinyl-aromatic compounds having up to 20 carbons, ethylenically unsaturated nitriles, vinyl halides, vinyl ethers of C₁-C₁₀ alcohols, C₂-C₈ aliphatic hydrocarbons with 1 or 2 double bonds, and mixtures of these monomers.

Preferred alkyl (meth)acrylates are C₁-C₁₀-alkyl (meth)acrylates, such as methyl methacrylate, methyl acrylate, n-butyl acrylate, ethyl acrylate and 2-ethylhexyl acrylate. Mixtures of alkyl (meth)acrylates can also be employed.

Examples of suitable vinyl esters of C₁-C₂₀ carboxylic acids include vinyl acetate, vinyl propionate, vinyl laurate, vinyl stearate, vinyl benzoate, vinyl 2-ethyl hexanoate and Versatic acid vinyl esters, with vinyl acetate being particularly preferred.

Suitable vinyl-aromatic compounds include vinyltoluene, α-and p-methylstyrene, α-butylstyrene, 4-n-butylstyrene, 4-n-decyl-styrene and, preferably, styrene.

Examples of suitable nitriles include acrylonitrile and methacrylonitrile.

Suitable vinyl halides include chloro-, fluoro- or bromo-substituted ethylenically unsaturated compounds, such as vinyl chloride and vinylidene chloride.

Examples of vinyl ethers are vinyl methyl ether and vinyl iso-butyl ether, with preference being given to vinyl ethers of C₁-C₄ alcohols.

Examples of suitable C₂-C₈ aliphatic hydrocarbons with one olefinic double bond include ethene and propene, whereas representative examples of C₂-C₈ aliphatic hydrocarbons having two olefinic double bonds include butadiene, isoprene and chloroprene.

In one embodiment, the present polymer dispersion is produced from a mixture of free-radically polymerizable main monomers comprising from 50 wt % to 99 wt % vinyl acetate and from 1 wt % to 40 wt % ethylene.

In addition to the main monomers discussed above, the aqueous polymerization mixture used to produce the present polymer dispersion may comprise up to 10 wt % of auxiliary ω-monomer(s) based on the total weight of monomers in the mixture. Such auxiliary ω-monomers can be those which promote better film or coating performance by the compositions herein or can provide films and coatings of desirable properties. Such desirable properties can include, for example, enhanced adhesion to surfaces or substrates, improved wet adhesion, better resistance to removal by scrubbing or other types of weathering or abrasion, and improved resistance to film or coating cracking. The optional ω-monomers useful for incorporation into the emulsion copolymers of the compositions herein are those which contain at least one polymerizable double bond along with one or more additional functional moieties. Suitable auxiliary ω-monomers include unsaturated organic acids, unsaturated silanes, glycidyl ω-monomers, ureido ω-monomers, ω-monomers with crosslinkable functions, crosslinking ω-monomers and combinations thereof.

Suitable auxiliary ω-monomers including unsaturated organic acids comprise ethylenically unsaturated carboxylic acids and anhydrides and amides thereof, ethylenically unsaturated sulfonic acids, and ethylenically unsaturated phosphonic acids.

For example, the auxiliary monomer may comprise an ethylenically unsaturated C₃-C₈ monocarboxylic acid and/or an ethylenically unsaturated C₄-C₈ dicarboxylic acid, together with the anhydrides or amides thereof. Examples of suitable ethylenically unsaturated C₃-C₈ monocarboxylic acids include acrylic acid, methacrylic acid and crotonic acid. Examples of suitable ethylenically unsaturated C₄-C₈ dicarboxylic acids include maleic acid, fumaric acid, itaconic acid and citraconic acid.

Examples of suitable ethylenically unsaturated sulfonic acids include those having 2-8 carbon atoms, such as vinylsulfonic acid, 2-acrylamido-2-methylpropanesulfonic acid, 2-acryloyloxyethanesulfonic acid and 2-methacryloyloxyethanesulfonic acid, 2-acryloyloxγ-and 3-methacryloyloxypropanesulfonic acid. Examples of suitable ethylenically unsaturated phosphonic acids also include those having 2-8 carbon atoms, such as vinylphosphonic acid and ethylenically unsaturated polyethoxyalkyletherphosphates.

In addition to or instead of said acids, it is also possible to use the salts thereof, preferably the alkali metal or ammonium salts thereof, particularly preferably the sodium salts thereof, such as, for example, the sodium salts of vinylsulfonic acid and of 2-acrylamidopropanesulfonic acid.

Unsaturated silanes usful as auxiliary ω-monomers can generally correspond to the structural Formula I:

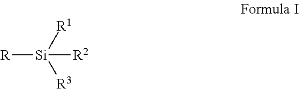

in which R denotes an organic radical olefinically unsaturated in the ω-position and R¹ R² and R³ which may be identical or different, denote the group -OZ, Z denoting hydrogen or primary or secondary alkyl or acyl radicals optionally substituted by alkoxy groups. Suitable unsaturated silane compounds of the Formula I are preferably those in which the radical R in the formula represents an ω-unsaturated alkenyl of 2 to 10 carbon atoms, particularly of 2 to 4 carbon atoms, or an ω-unsaturated carboxylic acid ester formed from unsaturated carboxylic acids of up to 4 carbon atoms and alcohols carrying the Si group of up to 6 carbon atoms. Suitable radicals R¹, R², R³ are preferably the group -OZ, Z representing primary and/or secondary alkyl radicals of up to 10 carbon atoms, preferably up to 4 carbon atoms, or alkyl radicals substituted by alkoxy groups, preferably of up to 3 carbon atoms, or acyl radicals of up to 6 carbon atoms, preferably of up to 3 carbon atoms, or hydrogen. Most preferred unsaturated silane ω-monomers are vinyl trialkoxy silanes.

Examples of preferred silane compounds of the Formula I include γ-methacryloxypropyltris(2-methoxyethoxy)silane, vinylmethoxysilane, vinyltriethoxysilane, vinyldiethoxysilanol, vinylethoxysilanediol, allyltriethoxysilane, vinyltripropoxysilane, vinyltriisopropoxysilane, vinyltributoxysilane, vinyltriacetoxysilane, trimethylglycolvinylsilane, γ-methacryloxypropyltrimethylglycolsilane, γ-acryloxypropyltriethoxysilane and γ-methacryloxypropyltrimethoxysilane.

Glycidyl compounds can also be used as optional auxiliary ω-monomers to impart epoxγ-functionality to the emulsion copolymer. Examples of suitable glycidyl optional ω-monomers include glycidyl acrylate, glycidyl methacrylate, allyl glycidyl ether, and vinyl glycidyl ether.

Another type of optional ω-monomer comprises cyclic ureido ω-monomers. Cyclic ureido ω-monomers are known to impart improved wet adhesion properties to films and coatings formed from copolymers containing these ω-monomers. Cyclic ureido compounds and their use as wet adhesion promoting ω-monomers are disclosed in U.S. Pat. Nos. 4,104,220; 4,111,877; 4,219,454; 4,319,032; 4,599,417 and 5,208,285. The disclosures of all of these U.S. patents are incorporated herein by reference in their entirety.

Another type of optional ω-monomer comprises ω-monomers with crosslinkable functions such as N-methylolacrylamide, N-methylolmethacrylamide, N-methylolallylcarbamate, N-methylolmaleimide, N-methylolmaleamic acid, and the N-methylol amides of aromatic vinyl carboxylic acids, such as N-methylol-p-vinylbenzamide. N-ethanol(meth)acrylamide, N-propanol(meth)acrylamide, the N-methylol esters or N-alkyl ethers or Mannich bases of N-methylol(meth)acrylamide or N-methylolallylcarbamate, acrylamidoglycolic acid and/or its salts, methyl acrylamidomethoxyacetate or N-(2,2-dimethoxy-1-hydroxyethyl)acrylamide.

A further group of comonomers suitable for preparing the emulsion polymers used herein comprises crosslinking monomers, such as comonomers with polyethylenic unsaturation, and hence with a crosslinking action. Examples include diallyl phthalate, diallyl maleate, triallyl cyanurate, tetraallyloxyethane, divinylbenzene, butane-1,4-diol dimethacrylate, triethylene glycol dimethacrylate, divinyl adipate, allyl (meth)acrylate, vinyl crotonate, methylenebisacrylamide, hexanediol diacrylate, pentaerythritol diacrylate and trimethylolpropane triacrylate.

The aqueous polymer dispersions employed in the present process will also generally contain one or more stabilizers in the form of emulsifiers, in particular nonionic emulsifiers and/or anionic emulsifiers, and/or protective colloids. Mixtures of different stabilizers can also be employed. The amount of stabilizer present in the polymer dispersion may be from 0.5 to 10 weight % of the total dispersion.

### Coating Compositions

In the present process, the aqueous polymer dispersions described above are combined with various adjuvants to produce coating compositions suitable for use as adhesives, paints, lacquers, varnishes and wood stains. When used in paint applications, the aqueous polymer dispersions are typically combined with one or more conventional fillers and/or pigments. In this context, pigments are understood as solids which have a refractive index greater than or equal to 1.75, whereas fillers are understood as meaning solids which have a refractive index of less than 1.75.

Preferred fillers useful in the paint compositions herein can be, for example, calcium carbonate, magnesite, dolomite, kaolin, mica, talc, silica, calcium sulfate, feldspar, barium sulfate and opaque polymers. Examples of white pigments useful in the paint compositions herein can be zinc oxide, zinc sulfide, basic lead carbonate, antimony trioxide, lithopone (zinc sulfide+barium sulfate) and, preferably, titanium dioxide. Examples of inorganic colored pigments which may preferably be used in the paint compositions herein include iron oxides, carbon black, graphite, luminescent pigments, zinc yellow, zinc green, Paris blue, ultramarine, manganese black, antimony black, manganese violet, bismuth vanadate or Schweinfurt green. Suitable organic colored pigments preferably are, for example, sepia, gamboge, Cassel brown, toluidine red, para red, Hansa yellow, indigo, azo dyes, anthraquinone and indigo dyes as well as dioxazine, quinacridone, phthalocyanin, isoindolinone and metal complex pigments of the azomethine series.

The fillers may be used as individual components. Mixtures of fillers such as, for example, calcium carbonate/kaolin and calcium carbonate/kaolin/talc have also been found to be particularly useful in practice. To increase the hiding power of the coating and to save on titanium dioxide, finely divided fillers such as, for example, finely divided calcium carbonate and mixtures of various calcium carbonates with different particle size distribution are frequently used. To adjust the hiding power, the shade and the depth of color of the coatings formed, the fillers are mixed with appropriate amounts of white pigment and inorganic and/or organic colored pigments.To disperse the fillers and pigments in water, auxiliaries based on anionic or non-ionic wetting agents, such as preferably, for example, sodium pyrophosphate, sodium polyphosphate, naphthalenesulfonate, sodium polyacrylate, sodium polymaleinates and polyphosphonates such as sodium 1-hydroxyethane-1,1-diphosphonate and sodium nitrilotris(methylenephosphonate), may be added.

Thickeners may also be added to the paint formulations herein. Thickeners which may be used include, inter alia, sodium polyacrylate and water-soluble copolymers based on acrylic and methacrylic acid, such as acrylic acid/acrylamide and methacrylic acid/acrylic ester copolymers. Hydrophobicaly-modified alkali soluble (acrylic) emulsions (HASE), hydrophobicallγ-modified ethoxylate (poly)urethanes (HEUR), hydrophobically-modified ethoxylate (poly)urethane alkali-swellable/soluble emulsions (HEURASE), polyether polyols (PEPO), polyuria, and cellulose ether based thickeners are also available. Inorganic thickeners, such as, for example, bentonites or hectorite, may also be used.

For various applications, it is sometimes also desirable to include small amounts of other additives, such as pH modifiers, and antifoamers, incorporated in the latex paint compositions herein. This may be done in a conventional manner and at any convenient point in the preparation of the latexes. Paint compositions produced herein are preferably free of any organic solvent, plasticizer or coalescent agent, namely so as to have a VOC content of less than 30g/1, preferably less than 1g/1, of the paint composition.

The invention will now be more particularly described with reference to the following non-limiting Examples.

### Example 1

### Polymer Dispersions and Testing

As preservative-free, aqueous polymer dispersions having a pH<7, the vinyl acetate/ethylene copolymer dispersion Mowilith LDM 1871 and the vinyl acetate/ethylene/vinyl decanoate dispersion Mowilith LDM 1828 from Celanese were produced without the addition of preservatives/biocides. The properties of the dispersions are listed in Table 1.

TABLE 1
Preservative free dispersions

| | Solid | pH | MFFT | Tg | Viscosity |
|---|---|---|---|---|---|
| Emulsion | [%] | value | (° C.) | (° C.) | (mPaS) |
| LDM 1828 | 50 | 6.5 | 0 | −3 | 1000 |
| LDM 1871 | 53 | 4.5 | 0 | 13 | 2000 |

To preserve the dispersions against microbial attack, the biocides listed in Table 2 were added to the dispersions. As comparative examples, no biocide or only CIT/MIT (3:1 blend) was added to additional samples of LDM 1871 and LDM 1828. The comparative examples are labeled as LDM 1871-Com 1/LDM 1871 Com 2 and LDM 1828-Com 1/LDM 1828 Com 2 in Tables 2 and 3.

TABLE 2

| Dispersion Examples | ppm CIT | ppm MIT | ppm DBNPA |
|---|---|---|---|
| LDM 1871-Com 1 | 0 | 0 | 0 |
| LDM 1871-Com 2 | 11 | 4 | 0 |
| LDM 1871-3 | 11 | 4 | 100 |
| LDM 1871-4 | 11 | 0 | 100 |
| LDM 1828-Com 1 | 0 | 0 | 0 |
| LDM 1828-Com 2 | 11 | 4 | 0 |
| LDM 1828-3 | 11 | 4 | 100 |
| LDM 1828-4 | 11 | 0 | 100 |

After 1 day storage the biocide content of the dispersions was measured by HPLC and the following challenge test was carried out.

100 g of the dispersions listed above are weighed into sterile sample bottles. To each sample 1% by weight of an inoculum is added and incubated at 30° C. for 7 days. As inoculum, a suspension in water which contains the following concentrations is used:

Bacteria: 8.0×10⁸−2.0×10⁹ cfu/cm³

Yeasts/moulds: 8.0×10⁶−2.0×10⁷ cfu/cm³

A mixture of the following bacteria, yeasts and fungi/moulds are used for the preparation of the inoculum:

Bacteria mixture of:

Aeromonas hydrophila (sorbia, BAM 485)

Alcaligenes faecalis (BAM 486)

Providencia rettgeri (BAM 488)

Pseudomonas aeruginosa (BAM 489)

Pseudomonas sp (BAM 490)

Escherichia coli (DSM 13631)

Staphylococcus aureus (DSM 346)

Micrococcus Luteus (DSM 20030)

Yeast mixture of:

Rhodotorula rubra (DSM 13621)

Saccharomyces cerevisiae (DSM 13622)

Issatchenkia orientalis (DSM 6128)

Filamentous Fungy mixture of:

Aspergillus terréus (DSM 13630)

Geotrichum candidum (DSM 13629)

Fusarium Solani (DSM 13635)

After 7 days the microbial contamination remaining in the samples is determined by streaking the samples out onto Trypticase Sel Agar (TSA) and on Malt Extra Agar (MEA) as nutrient media and incubated at 30° C. for 7 days. The level of growing is measured by using a rating of 0 for no growth up to a rating of 3 for full growth. The test is passed in case no growth is observed which means a rating of 0 on TSA and MEA nutrient media. After passing the first challenge cycle the test is repeated up to six times by adding again the inoculum to the sample and measuring the growth on TSA and MEA again as described. A sufficient protection is given in case a sample pass 6 challenge cycles.

The results the biocide measurements and the challenge test are shown in Table 3.

TABLE 3

| Dispersion | ppm CIT | ppm MIT | ppm DBNPA | Challenges | |
|---|---|---|---|---|---|
| Examples | after 7 d | after 7 d | after 1 d | passed | Protection |
| LDM 1871-Com 1 | 0 | 0 | 0 | 0 | insufficient |
| LDM 1871-Com 2 | 10 | 4 | 0 | 4 | insufficient |
| LDM 1871-3 | 11 | 4 | 70 | 6 | sufficient |
| LDM 1871-4 | 10 | <0.5 | 72 | 6 | sufficient |
| LDM 1828-Com 1 | 0 | 0 | 0 | 0 | insufficient |
| LDM 1828-Com 2 | 11 | 3 | 0 | 4 | insufficient |
| LDM 1828-3 | 10 | 4 | 65 | 6 | sufficient |
| LDM 1828-4 | 11 | <0.5 | 68 | 6 | sufficient |

For effective preservation and to guarantee a shelf life of 6 months, a dispersion has to pass challenge level 6. It will be seen from Table 3 that only the dispersions containing DBNPA and CIT exhibited sufficient protection.

### EXAMPLE 2

### Paint Preparation and pH Adjustment

Paints were produced from the dispersions listed in Table 2 according to the following recipe:

| Ingredients | Supplier | p.b.w. |
|---|---|---|
| Water | | 178.0 |
| Tylose H 6.000 YP2 | SE Tylose | 2.0 |
| Lopon LF | ICL Performance Products | 4.0 |
| Agitan 295 | Münzing Chemie | 4.0 |
| Kronos 2190 | Kronos Titan | 200.0 |
| Omyacarb extra | Omya | 150.0 |
| NaOH, 10% | | 2.0 |
| Tafigel PUR 50 | Münzing Chemie | 15.0 |
| Dispersion according table 3 | Celanese | 460.0 |
| | | 1015.0 |

The pH of each paint was adjusted to a value of 9.0 by the addition of sodium hydroxide and, after 1 day, the biocide concentration of each paint was measured. The results are summarized in Table 4, from which it will be seen that no DBNPA was detectable in any of the paint compositions.

TABLE 4
Biocide concentration in paint 1 day after NaOH addition

| Paint example | ppm CIT | ppm MIT | ppm DBNPA |
|---|---|---|---|
| Paint LDM 1871-Com 1 | 0 | 0 | 0 |
| Paint LDM 1871-Com 2 | 4 | <0.5 | 0 |
| Paint LDM 1871-3 | 4 | <0.5 | 0 |
| Paint LDM 1871-4 | <0.5 | <0.5 | 0 |
| Paint LDM 1828-Com 1 | 0 | 0 | 0 |
| Paint LDM 1828-Com 2 | 4 | <0.5 | 0 |
| Paint LDM 1828-3 | 4 | <0.5 | 0 |
| Paint LDM 1828-4 | 2 | <0.5 | 0 |

### EXAMPLE 3

### Addition of Cysteine

To each of the paint examples according to Table 4, an amount of 15 ppm cysteine was added. After one day the biocide concentration was measured again and the results are listed in Table 5.

TABLE 5
Biocide concentration in paint 1 day after addition of cysteine

| Paint examples | ppm CIT | ppm MIT | ppm DBNPA |
|---|---|---|---|
| Paint LDM 1871-Com 1 | 0 | 0 | 0 |
| Paint LDM 1871-Com 2 | <0.5 | <0.5 | 0 |
| Paint LDM 1871-3 | <0.5 | <0.5 | 0 |
| LDM 1871-4 | <0.5 | <0.5 | 0 |
| LDM 1828-Com 1 | 0 | 0 | 0 |
| LDM 1828-Com 2 | 0 | <0.5 | 0 |
| LDM 1828-3 | <0.5 | <0.5 | 0 |
| LDM 1828-4 | <0.5 | <0.5 | 0 |

It will be seen from Table 5, one day of the addition of cysteine, no CIT was detectable to a dectection limit of 0,5 ppm in any of the paint compositions.

### EXAMPLE 4

### Adjustment of the pH of the paint>10.5

After the addition of the cysteine as described in Example 4, potassium silicate was added to each paint to raise the pH of the paint to >10.5. After one day of storage the biocide concentration was measured and the results are listed in Table 6.

TABLE 6
Biocide concentration in paint 1 day
after addition of potassium silicate

| Paint example | ppm CIT | ppm MIT | ppm DBNPA |
|---|---|---|---|
| Paint LDM 1871-Com 1 | 0 | 0 | 0 |
| Paint LDM 1871-Com 2 | <0.5 | <0.5 | 0 |
| Paint LDM 1871-3 | <0.5 | <0.5 | 0 |
| LDM 1871-4 | <0.5 | <0.5 | 0 |
| LDM 1828-Com 1 | <0.5 | <0.5 | 0 |
| LDM 1828-Com 2 | <0.5 | <0.5 | 0 |
| LDM 1828-3 | <0.5 | <0.5 | 0 |
| LDM 1828-4 | <0.5 | <0.5 | 0 |

It will be seen from Table 6 that no biocide was detectable in any of the paint compositions 1 day after the potassium silicate addition.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A process for producing an aqueous coating composition, the process comprising:
(i) providing an aqueous polymer dispersion having a pH <7;
(ii) adding to the dispersion 1 to 30 ppm of 5-chloro-2-methyl-3(2H)-isothiazolone (CIT) and 10 to 1000 ppm of 2,2-dibromo-3-nitrilopropionamide (DBNPA), all by weight of the total weight of the dispersion; and
(iii) adding at least one adjuvant to the dispersion to produce a coating composition;
(iv) raising the pH of the coating composition to a value sufficient to decompose the DBNPA; and
(v) adding a CIT-decomposing compound to the coating composition to decompose the CIT.

2. The process of claim 1, wherein step (ii) comprises adding to the dispersion 5 to 20 ppm by weight, preferably 10 to 14.9 ppm by weight of CIT based on the total weight of the dispersion.

3. The process of claim 1, wherein 20 to 400 ppm, preferably about 100 ppm, of DBNPA by weight based on the total weight of the dispersion are added in (ii).

4. The process of claim 1, wherein step (iv) comprises raising the pH of the coating composition to >8.

5. The process of claim 1, wherein step (iv) comprises raising the pH of the coating composition to >8 and up to 10.

6. The process of claim 1, wherein step (v) comprises adding cysteine to the coating composition.

7. The process of claim 1, and further comprising:
(vi) adding to the coating composition 50 to 300 ppm, preferably 50 to 250 ppm, by weight zinc pyrithrione and/or 50 to 500, preferably 75 to 350 ppm, by weight of 1,2-benzisothiazolin-3-one (BIT) and/or 50 to 150 ppm by weight of 2-bromo-2-nitro-1,3-propanediol based on the total weight of the coating composition to preserve the coating composition against microbial attack.

8. A process for producing an aqueous coating composition, the process comprising:
(i) providing an aqueous polymer dispersion having a pH <7;
(ii) adding to the dispersion 1 to 30 ppm of 5-chloro-2-methyl-3(2H)-isothiazolone (CIT), up to 10 ppm of 2-methyl-3(2H)-isothiazolone (MIT) and 10 to 1000 ppm of 2,2-dibromo-3-nitrilopropionamide (DBNPA), all by weight of the total weight of the dispersion; and
(iii) adding at least one adjuvant to the dispersion to produce a coating composition; and
(iv) adjusting the pH of the coating composition to a value of at least 10.5, preferably between 10.5 to 11.5, to decompose the DBNPA, CIT and, if present, MIT and to preserve the coating composition against microbial attack.

9. The process of claim 8, wherein step (ii) comprises adding to the dispersion up to 3 ppm, preferably up to 1 ppm, MIT based on the total weight of the dispersion.

10. The process of claim 8, wherein, after step (ii), the dispersion contains no measurable amount of MIT.

11. The process of claim 8, wherein step (ii) comprises adding to the dispersion 5 to 20 ppm by weight, preferably 10 to 14.9 ppm by weight of CIT based on the total weight of the dispersion.

12. The process of claim 8, wherein 20 to 400 ppm, preferably about 100 ppm, of DBNPA by weight based on the total weight of the dispersion are added in (ii).

13. The process of claim 1, wherein the pH adjusting step (iv) comprises adding one or more of an alkali metal hydroxide, an alkali metal silicate, an alkylalkoxysilane, an alkylalkoxysiloxane and an alkysiliconate to the coating composition.

14. An aqueous coating composition produced by the process of claim 1.

15. An adhesive, paint, lacquer or varnish comprising the coating composition of claim 14.

16. An interior paint comprising the coating composition of claim 14.

17. A preservative-free interior paint comprising a coating composition produced by the process of claim 8.
